(19) United States
(12) Patent Application Publication
(10) Pub. No.: US 2022/0224117 A1
(43) Pub. Date: Jul. 14, 2022

(54) MULTI-CHANNEL FREQUENCY CONTAINMENT RESERVE, METHOD AND SYSTEM FOR PROVIDING CONTROL POWER FOR CONTROLLING A NETWORK FREQUENCY OF A POWER NETWORK AND POWER NETWORK

(71) Applicant: TRIMET ALUMINIUM SE, Essen (DE)

(72) Inventor: Heribert HAUCK, Krefeld (DE)

(21) Appl. No.: 17/610,918

(22) PCT Filed: Apr. 14, 2020
(86) PCT No.: PCT/EP2020/060402

§ 371 Date: Nov. 12, 2021

(30) Foreign Application Priority Data
May 13, 2019 (EP) 19174037.2

(51) Int. Cl. H02J 3/24; H02J 3/46; G06Q 50/06

(52) U.S. Cl. CPC H02J 3/241; G06Q 50/06; H02J 3/46

(57) ABSTRACT

Provided is a system and a method for providing a control power for controlling a network frequency of a power network, which is operated at a nominal network frequency, in the event of a frequency deviation of the network frequency from the nominal network frequency. A time curve of the frequency deviation is spectrally split into at least two different spectral ranges, where each of the spectral ranges is assigned to one of at least two different technical units for providing control power. The required control power is then provided individually or jointly by the technical units in accordance with the spectral split of the time curve of the frequency deviation, where a respective power share, of each technical unit, in the control power corresponds to the spectral share, in the time curve of the frequency deviation, of the spectral range assigned to the corresponding technical unit.

### BACKGROUND

### Technical Field

The present invention relates to a method for providing a control power for controlling a network frequency of a power network, which is operated at a nominal network frequency, in the event of a frequency deviation of the network frequency from the nominal network frequency.

The present invention further relates to a system for providing a control power for controlling a network frequency of a power network, which is operated at a nominal network frequency, in the event of a frequency deviation of the network frequency from the nominal network frequency, the system comprising at least two different technical units for providing control power.

Lastly, the present invention relates to a power network having a nominal network frequency and a network frequency that deviates therefrom by a frequency deviation.

### Description of the Related Art

Control power, which is also known as “reserve power,” ensures that private and industrial power consumers are supplied with exactly the amount of electrical power required, despite considerable fluctuations in power demand and power supply in the power network. For this purpose, in the short term, power adjustments can be implemented in controllable power stations, fast start-up power stations (e.g., gas turbine power stations) can be started up or pumped-storage power stations can be deployed. In addition, industrial power consumers in particular can use load control to reduce or entirely stop their power draw from the network.

The control power is thus equal to differences between the feed-in into the power network and the feed-out out of the power network. In the process, the required control power is determined on the basis of the standard network frequency in the entire power network. The power network functions on the basis of a nominal network frequency, for example 50 Hz in Europe, which constitutes the setpoint of the network frequency. If more power is fed into the power network than is drawn out, the network frequency increases since the power network cannot store any energy. In the opposite situation, i.e., in the event of a higher feed-out or power draw than feed-in, the network frequency drops. In the present context, the difference between the actual network frequency and the nominal network frequency is referred to as the frequency deviation.

Against this background, network operators procure various control-power products as part of their duty to reliably operate the transmission network. The most sophisticated of these products is the so-called “frequency containment reserve” (FCR). This control-energy product ensures that the network frequency is constantly kept within particular permitted limits.

In Europe, for example, the frequency containment reserve has to be provided within 30 seconds in the event of frequency deviations of up to 200 millihertz (mHz) from the nominal network frequency of 50.0 hertz (Hz) whether upwards or downwards, i.e., at frequencies of between 49.8 Hz and 50.2 Hz. In the process, very small deviations of less than 10 mHz, i.e., when the network frequency is between 49.99 Hz and 50.01 Hz, are not corrected in some circumstances.

One problem with providing frequency containment reserve is the relatively high speed at which the network frequency changes in relation to the nominal network frequency. Tracking all changes to the frequency deviation places very high requirements on the technical units intended for providing the control power. Industrial power consumers in particular have to register huge drops in efficiency if they have to adjust their procedural processes in line with the high change speed of the network frequency.

It is therefore often difficult and financially unattractive for a single technical unit (e.g., a power station or a procedural process of an industrial power consumer such as an industrial facility) to deliver the frequency containment reserve alone and in a manner that meets the requirements.

To mitigate the high change speeds, there are concepts for delivering so-called “synthetic frequency containment reserve.” The most well-known method is to split the control band of, for example, +/−200 mHz into a plurality of sub-bands, e.g., a symmetrical core band of +/−100 mHz, i.e., 49.9 Hz to 50.1 Hz, and two side bands, each of +/−(100-200) mHz, i.e., 49.8 Hz to 49.9 Hz and 50.1 Hz to 50.2 Hz, which are served by different suppliers and “synthesized” by an aggregator to form the total product required. Products of this kind are thus also referred to as “synthetic FCR.” EP 3 136 532 A1, for example, describes a system and a method for a synthetic frequency containment reserve of this kind. This document makes use of the idea that a large portion of the control power takes place in the core band whereas large control powers are less frequently demanded in the side bands, which relieves the burden on the technical units that are responsible for this, which have a high energy shift capacity or storage capacity.

In the side bands too, however, i.e., for network frequencies further away from the nominal network frequency, the frequency deviation changes at a high speed. As a result, while the technical units responsible for the side bands are indeed used less frequently in the method known from the prior art, when they are used their efficiency is again severely affected by the high change rate of their power draw from the power network.

The problem thus persists of the relatively high speed at which the network frequency changes in relation to the nominal network frequency and the associated huge drops in efficiency when industrial power consumers have to adjust their procedural processes in line with the high change speed of the network frequency in order to contribute to the frequency containment reserve.

US 2013/0321040 A1 discloses a method and a system for using a load signal to provide frequency regulation.

DE 10 2012 113 051 A1 and DE 10 2011 055 231 A1 relate to methods for providing control power to stabilize an AC power network, comprising an energy storage device.

WO 2014/208292 A1 describes a system for power stabilization and a corresponding control device for compensating for frequency deviations.

### BRIEF SUMMARY

One or more embodiments are directed to a method and a system for providing a control power in the above-mentioned technical field, as a result of which it is possible, in a more efficient way, to use an industrial power consumer for the frequency control of a power network, in particular for primary control.

A method and system are provided.

The method for providing a control power for controlling a network frequency of a power network, which is operated at a nominal network frequency, in the event of a frequency deviation of the network frequency from the nominal network frequency is characterized in that a time curve of the frequency deviation is spectrally split into at least two different spectral ranges, each of the spectral ranges being assigned to one of at least two different technical units for providing control power. The required control power is provided individually or jointly by the technical units in accordance with the spectral split of the time curve of the frequency deviation, wherein a respective power share, of each technical unit, in the control power corresponds to the spectral share, in the time curve of the frequency deviation, of the spectral range that is assigned to the corresponding technical unit.

In other words, the speed at which the frequency deviation changes, i.e., increases or decreases, is used to select a suitable technical unit for providing a corresponding control power such that the control can be carried out efficiently. Specifically, in this way the frequency deviation is split into a slowly changing share and a quickly changing share. The slowly changing share has a larger amplitude compared with the quickly changing share, i.e., it needs more control power in order to be corrected, whereas the quickly changing share has a smaller amplitude than the slowly changing share, i.e., can be corrected by a smaller control power.

The splitting of the control power in accordance with the spectral split of the time curve of the frequency deviation makes it possible, in order to provide quickly changing control powers, to select, in a targeted manner, technical units that only have to have a small energy shift capacity or storage capacity in relation to the large procedural processes. These include, for example, supercapacitors (supercaps), flywheel energy stores or batteries.

An advantageous consequence is that the power-intensive share in the frequency deviation can be corrected by a slower-acting technical unit, e.g., a procedural process in an industrial facility, power station or the like that only changes slowly. Due to the separation of the quickly changing share in the control power, the speed of the change in the power share provided by the slower-acting technical unit can be kept lower than in the prior art. As a result, the control power can overall be provided more efficiently than in the prior art because the slower-acting technical unit does not need to track every change in the frequency deviation once the quickly changing frequency deviation has been corrected or at least mitigated by the quicker technical unit. The sum of the quicker technical unit and the slower-acting technical unit thus makes the required control power available more efficiently overall, even when the frequency deviation adopts extreme values, i.e., for example more than 100 mHz.

Preferably, the time curve of the frequency deviation is split into a high-pass share and a residual share, or into a low-pass share and a residual share, or into a high-pass share and a low-pass share.

Therefore, to spectrally split the time curve of the frequency deviation, an analogue or digital high-pass filter can filter out high change speeds (high-pass share) and assign a corresponding power share of the control power to a comparatively quick technical unit, whereas a power share, corresponding to the remainder of the frequency deviation (the residual share), of the control power is assigned to a slow-acting technical unit.

Analogously, to spectrally split the time curve of the frequency deviation, an analogue or digital low-pass filter can filter out low change speeds (low-pass share) and assign a corresponding power share of the control power to a comparatively slow-acting technical unit, whereas a power share, corresponding to the remainder of the frequency deviation (the residual share), of the control power is assigned to a quick technical unit.

Likewise, to spectrally split the time curve of the frequency deviation, an analogue or digital high-pass filter can filter out high change speeds (high-pass share) and assign a corresponding power share of the control power to a comparatively quick technical unit, whereas an analogue or digital low-pass filter can filter out low change speeds (low-pass share) and assign a corresponding power share of the control power to a slow-acting technical unit. A power share, corresponding to any remainder of the frequency deviation (the residual share), of the control power can then be assigned to a further technical unit that can be classified between the quick and the slow-acting technical unit in terms of its speed and can, but need not, also possibly have an energy shift capacity or storage capacity that can be classified between said technical units.

The determined values of the time curve of the frequency deviation can then be assessed, for example by means of an algorithm or frequency-dependent circuits (also in the context of equivalent circuits), as being above or below a threshold value and accordingly assigned to a spectral range above the threshold value or to a spectral range below the threshold value.

Of the at least two technical units, a first technical unit, assigned to a first spectral range, has a first reaction speed and a first energy shift capacity or storage capacity, whereas a second technical unit, assigned to a second spectral range, has a second reaction speed and a second energy shift capacity or storage capacity. In the process, the first spectral range covers a slower frequency deviation than the second spectral range and the first technical unit has a lower reaction speed and a higher energy shift capacity or storage capacity than the second technical unit.

Alternatively, it is also possible for the second technical unit to have a higher reaction speed and simultaneously a higher energy shift capacity or storage capacity than the first technical unit. By using the embodiment, the method for providing the control power is particularly efficient because costs for a high energy shift capacity or storage capacity of the second technical unit are not incurred to the same extent as in the embodiment stated as an alternative.

Preferably, the control power is provided for the primary control of the power network. This means that the control power has to be able to be available in its entirety quickly, for example within 30 seconds, and is intended to correct a first frequency deviation of, for example, up to 200 mHz, potentially even beyond a dead zone or dead band of, for example, 10 mHz, around the nominal network frequency of, for example, 50 Hz.

The method of a particularly embodiment basically involves a frequency-deviation signal, taken as the basis for the control in the form of a setpoint, being split into at least a high-pass and a low-pass or residual share by means of a spectral split of the time curve thereof, similarly to a diplexer of a two-way or multi-way loudspeaker system, the split frequency shares of different technical units being processed as the setpoint for forming a particular control-energy share. The sum of the two or more control-energy contributions can then be the full control power, in particular the frequency containment reserve, required by the network operator.

The system for providing a control power for controlling a network frequency of a power network, which is operated at a nominal network frequency, in the event of a frequency deviation of the network frequency from the nominal network frequency, said system comprising at least two different technical units for providing control power, is characterized in that the system comprises a controller which is configured, on the basis of a spectral split of a time curve of the frequency deviation into at least two different spectral ranges for providing a respective power share of the control power, to actuate the technical units in such a way that the power shares of the technical units combine to form the control power. The controller preferably comprises a processor, which is adjusted such that the technical units are actuated in such a way, on the basis of the spectral split of the time curve of the frequency deviation into at least two different spectral ranges for providing the respective power share of the control power, that the power shares of the technical units combine to form the control power.

Preferably, the controller or processor is configured to carry out the above-described method in one embodiment. Alternatively, the controller can also carry out other method steps in order to actuate the technical units accordingly. For example, it is not strictly necessary for the controller itself to spectrally split the time curve of the frequency deviation, but rather an accordingly prepared signal can also be generated at a different site.

Preferably, the first technical unit is a procedural process of an industrial plant, for example an aluminum electrolysis process. It can also be a power station or another element that is connected to the power network and is comparatively slow in terms of its time dynamics and preferably has a relatively high energy shift capacity or storage capacity. The second technical unit can preferably be a supercapacitor, a flywheel energy store or a battery, or also another element that is connected to the power network and is comparatively quick in terms of its time dynamics and preferably has a relatively low energy shift capacity or storage capacity. These technical units enable particularly efficient control of the network frequency.

A power network having a nominal network frequency and a network frequency that deviates therefrom by a frequency deviation is characterized in that it is operatively connected to an above-described system.

Further advantages and developments become apparent from the following description of the drawings and from all the claims.

### BRIEF DESCRIPTION OF THE SEVERAL VIEWS OF THE DRAWINGS

FIG. 1 is a block diagram of a system according to an embodiment.

FIG. 2 is a block diagram of a system according to an embodiment.

FIG. 3 shows an example time curve of a network frequency.

FIG. 4 shows an example time curve of a frequency deviation.

FIG. 5 shows a high-frequency spectral range of the example time curve of the frequency deviation from FIG. 4.

FIG. 6 shows a low-frequency spectral range of the example time curve of the frequency deviation from FIG. 4.

### DETAILED DESCRIPTION

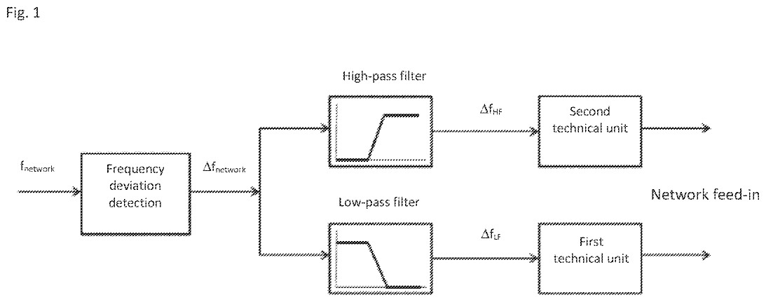

FIG. 1 is a block diagram of a system according to a first embodiment. In the system shown in FIG. 1, the network frequency f_{network} of a power network operated at a nominal network frequency is fed in and a frequency deviation Δf_{network} is thus continuously detected. As a result, the time curve of the frequency deviation Δf_{network} can be determined.

By means of an arrangement of a high-pass filter and a low-pass filter, said arrangement being fed with the continuously detected frequency deviation Δf_{network}, the frequency deviation Δf_{network} can be spectrally split into two different spectral ranges. As such, a high-frequency spectral range Δf_{HF} of the time curve of the frequency deviation Δf_{network} is generated by the high-pass filter, whereas a low-frequency spectral range Δf_{LF} of the time curve of the frequency deviation Δf_{network} is generated by the low-pass filter.

In the embodiment shown here, the high-pass filter and the low-pass filter are configured such that they seamlessly adjoin each other and thus combine to form the frequency deviation Δf_{network}. Alternatively to the embodiment shown in FIG. 1, one or more further filters can also be provided in order to split the frequency deviation Δf_{network} into even more spectral ranges.

The high-frequency spectral range Δf_{HF} of the time curve of the frequency deviation Δf_{network} is fed by the high-pass filter into the second technical unit (e.g., power station, power consumer, supercapacitor, energy storage device or battery, among others), which is thus assigned to the high-frequency spectral range Δf_{HF} so that said second technical unit provides a power share, in a total control power provided by the system, that corresponds to the high-frequency spectral range Δf_{HF}. In the process, the second technical unit is preferably selected such that it has a high reaction speed in order to be able to effectively and efficiently provide its power share in the total control power in accordance with the high-frequency spectral share of the frequency deviation Δf_{network}. For example, the second technical unit can be a supercapacitor, a flywheel energy store or a battery.

Analogously, the low-frequency spectral range Δf_{LF} of the time curve of the frequency deviation Δf_{network} is fed by the low-pass filter into the first technical unit, which is thus assigned to the low-frequency spectral range Δf_{LF} so that said first technical unit provides a power share, in a total control power provided by the system, that corresponds to the low-frequency spectral range Δf_{LF}. In the process, the first technical unit is preferably selected such that it has a high energy shift capacity or storage capacity in order to be able to effectively and efficiently provide its power share in the total control power in accordance with the high amplitudes, as shown in the following graphs, of the low-frequency spectral share of the frequency deviation Δf_{network}. For example, the first technical unit can be a procedural process, such as an aluminum electrolysis process, or a power station.

The power shares of the first and the second technical unit are fed into the power network together as the control power, preferably as the frequency containment reserve, in order to keep the network frequency as close as possible to the nominal network frequency of the power network.

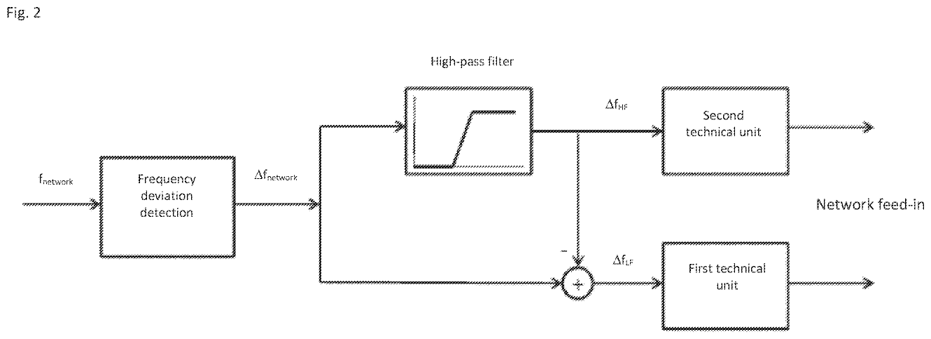

FIG. 2 is a block diagram of a system according to a second embodiment. The basic structure of the system according to the second embodiment is similar to that of the first embodiment and repetitive descriptions are not provided.

Unlike the first embodiment from FIG. 1, the system according to FIG. 2 does not include a low-pass filter, but rather only a high-pass filter. Like in the first embodiment, the high-frequency spectral range Δf_{HF} of the time curve of the frequency deviation Δf_{network} is generated by the high-pass filter. To be able to provide the total control power, a residual share of the time curve of the frequency deviation Δf_{network} is determined in addition to the high-frequency spectral range Δf_{HF} of the time curve of the frequency deviation Δf_{network}, by subtracting the high-frequency spectral range Δf_{HF} from the frequency deviation Δf_{network}. The thus remaining residual share corresponds exactly to the low-frequency spectral range Δf_{LF} determined by the low-pass filter in the first embodiment, but does not require the use of a low-pass filter.

The reverse procedure is also possible, whereby the high-pass filter of the embodiment shown in FIG. 1 is omitted and the high-frequency spectral range Δf_{HF} of the time curve of the frequency deviation Δf_{network} is determined by subtracting the low-frequency spectral range Δf_{HF} from the frequency deviation Δf_{network}.

The block diagrams from FIGS. 1 and 2 are equivalent circuit diagrams, which are intended to illustrate, using conventional switch elements, how a system for providing control power can be constructed. In current practice, the high-pass filters and low-pass filters are often represented by digital elements. Lastly, it is sufficient to bring about the spectral split, which is readily possible using modern computers.

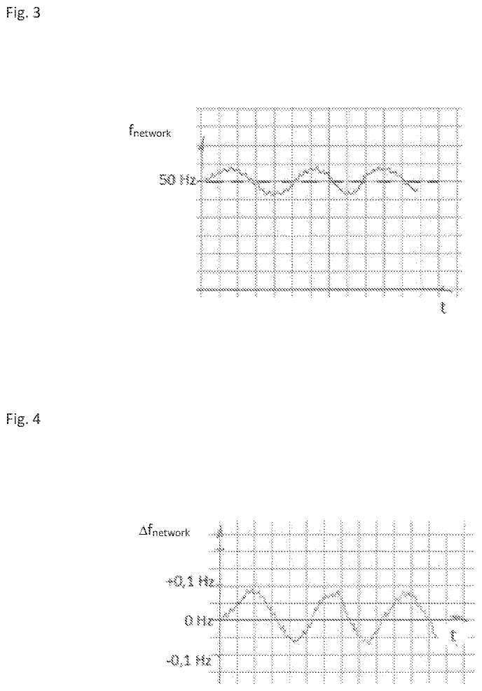

FIG. 3 shows an example time curve of a network frequency f_{network}. This curve is an example of a signal that is fed into the system shown in FIGS. 1 and 2. The network frequency f_{network} is shown in FIG. 3 as a “shaky wave” that fluctuates around the nominal network frequency, which, by way of example, is 50 Hz in FIG. 3. The amplitude and the curve of the network frequency f_{network} result from the sum of the power fed into and drawn from the power network. The aim of (frequency) control, in particular primary control, is to even out these fluctuations, i.e., to make the shaky wave as straight a line as possible at 50 Hz. This can be achieved if the power surplus (at an excessive network frequency) or shortfall (at an insufficient frequency) in the power network, which leads to the fluctuation of the network frequency f_{network}, is compensated for by additional consumers/by reducing the power feed-in (at an excessive network frequency) or by reducing the consumption/increasing the power feed-in (at an insufficient network frequency).

FIG. 4 shows an example time curve of a frequency deviation Δf_{network}. This curve is an example of a signal that results from the apparatus for detecting the frequency deviation Δf_{network} and can then be fed into the high-pass filter and/or low-pass filter in order to be spectrally split. The frequency deviation Δf_{network} is determined from the measured network frequency f_{network} and results from the difference between the network frequency f_{network} and the nominal network frequency, which is 50 Hz in this example. This time curve, which fluctuates between approximately −100 mHz and +100 mHz in the present example, has to be compensated for. As is readily clear from the graph in FIG. 4, a quick, low-amplitude oscillation is superimposed on a slow, high-amplitude oscillation, thereby leading to the shaky wave. Provided herein is separating these two spectral shares of the wave from one another and compensating for them separately to be able to make targeted use of the strengths of the individual available technical units for the frequency control and thus achieve an efficiency increase overall.

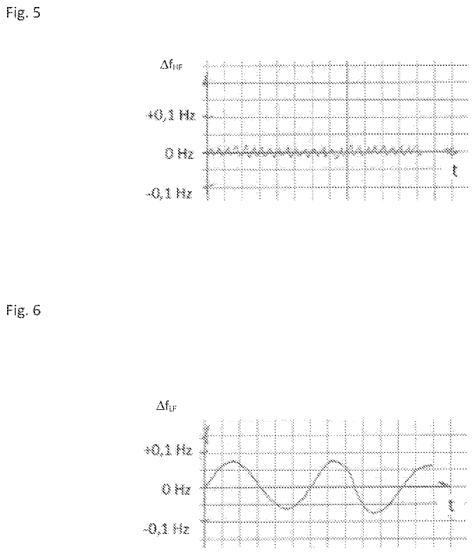

FIG. 5 shows a high-frequency spectral range of the example time curve of the frequency deviation Δf_{network} from FIG. 4. This signal is an example of a share, resulting from the high-pass filter, of the time curve of the frequency deviation Δf_{network} in the high-frequency spectral range Δf_{HF}, which can be fed into the second technical unit in order to specify its power share in the control power.

FIG. 6 shows a low-frequency spectral range of the example time curve of the frequency deviation from FIG. 4. This signal is an example of a share, resulting from the low-pass filter, of the time curve of the frequency deviation Δf_{network} in the low-frequency spectral range Δf_{HF}, which can be fed into the first technical unit in order to specify its power share in the control power. The residual share of the frequency deviation Δf_{network} according to the embodiment from FIG. 2 looks exactly the same as said low-frequency spectral range Δf_{LF}.

Comparing FIGS. 5 and 6, it is clear that a spectral split of the total frequency deviation into a high-frequency share and a low-frequency share makes it possible to be able to provide high control power having comparatively slow fluctuations, thereby hugely increasing the efficiency of the control. This is possible because the quick fluctuations of the frequency deviation, i.e., the high-frequency share, only requires a small control power, i.e., has small amplitudes. Therefore, a quick but weak technical unit can be used to compensate for the quick, small fluctuations whereas a slow but strong technical unit can take on the compensation of the large, slow fluctuations. The finding that this splitting of the signal can be mapped in a split onto technical units makes it possible to provide a particularly efficient synthetic control power, in particular frequency containment reserve. The disclosure can be referred to as a “multi-channel frequency containment reserve,” based on a similar principle in multi-channel loudspeaker systems.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for providing a control power for controlling a network frequency of a power network, which is operated at a nominal network frequency, in an event of a frequency deviation of the network frequency from the nominal network frequency, comprising:
spectrally splitting a time curve of the frequency deviation into at least two different spectral ranges that are different; and
assigning the at least two spectral ranges to at least two technical units, respectively, for providing control power, the at least two technical units being different from each other, wherein:
the control power is provided individually or jointly by the at least two technical units in accordance with the splitting of the time curve of the frequency deviation, and
a respective power share, of a technical unit of the at least two technical units, in the control power corresponds to a spectral share, in the time curve of the frequency deviation, of a spectral range assigned to the technical unit.

2. The method according to claim 1, wherein the time curve of the frequency deviation is split into:
a first high-pass share and a first residual share, or
a first low-pass share and a second residual share, or
a second high-pass share and a second low-pass share.

3. The method according to claim 1, wherein:
a first technical unit of the at least two technical units that is assigned to a first spectral range has a first reaction speed and a first energy shift capacity or storage capacity,
a second technical unit of the at least two technical units that is assigned to a second spectral range has a second reaction speed and a second energy shift capacity or storage capacity,
the first spectral range covers a slower frequency deviation than the second spectral range, and
the first technical unit has a lower reaction speed and a higher energy shift capacity or storage capacity than the second technical unit.

4. The method according to claim 1, wherein the control power is provided for a primary control of the power network.

5. A system for providing a control power for controlling a network frequency of a power network, which is operated at a nominal network frequency, in an event of a frequency deviation of the network frequency from the nominal network frequency, comprising:
at least two technical units for providing control power, the at least two technical units being different from each other; and
a controller configured to:
operate the at least two technical units to cause the power shares of the at least two technical units combine to form the control power, operating the at least two technical units being based on a spectral split of a time curve of the frequency deviation into at least two different spectral ranges for providing to each technical unit a respective power share of the control power.

6. (canceled)

7. The system according to claim 5, wherein:
a first technical unit of the at least two technical units has a first reaction speed and a first energy shift capacity or storage capacity,
a second technical unit of the at least two technical units has a second reaction speed and a second energy shift capacity or storage capacity, and
the first technical unit has a lower reaction speed and a higher energy shift capacity or storage capacity than the second technical unit.

8. The power network having the nominal network frequency and the network frequency, wherein the power network is operatively connected to the system according to claim 5.

9. The method according to claim 1, wherein each technical unit of the at least two technical units is a power station, a power consumer, a supercapacitor, an energy storage device or a battery.

10. The system according to claim 5, wherein each technical unit of the at least two technical units is a power station, a power consumer, a supercapacitor, an energy storage device or a battery.

11. The system according to claim 7, wherein the first technical unit is an aluminum electrolysis process.

12. The system according to claim 7, wherein the second technical unit is a supercapacitor, a flywheel energy store device or a battery.
